(19) United States
(12) Patent Application Publication
(10) Pub. No.: US 2007/0232763 A1
(43) Pub. Date: Oct. 4, 2007

(54) Naphthalate based polyester resin compositions

(75) Inventors: Sanjay Tammaji Kulkarni, Chennai (IN); Balasundaram Dilly Raj, Chennai (IN)

Correspondence Address: DOCKETING SPECIALIST;SULLIVAN & WORCESTER LLP, ONE POST OFFICE SQUARE, BOSTON, MA, 02109, US

(73) Assignee: Futura Polyesters Limited, Chennai (IN)

(21) Appl. No.: 11/657,413

(22) Filed: Jan. 24, 2007

(30) Foreign Application Priority Data
Jan. 30, 2006 (IN) 139/MUM/2006

(51) Int. Cl. C08L 67/02; C08G 63/02; B32B 27/36

(52) U.S. Cl. 525/437; 528/272

(57) ABSTRACT

The invention provides polyester polymers suitable for production of monolayer and multilayer preforms and containers by a process of injection molding or co-injection molding and stretch blow molding technology for monolayer and multilayer containers. Containers of the invention not only have adequate CO₂ barriers, but also have adequate O₂ and UV barriers, high thermal stability, and burst strength to withstand tunnel pasteurization processes at about 60° C. for 20-30 minutes at 10 bar CO₂ pressure for beer applications. There will further be no limitations due to humidity in respect of processing the resin/preforms and storage of preforms beyond what is required for normal PET. The polymers of the invention do not possess tie layer nor delamination problems and satisfy recycling criteria.

### CROSS REFERENCE TO RELATED APPLICATIONS

This application claims the benefit of Indian Provisional Application Serial No. 139/MUM/2006, filed on Jan. 30, 2006, which is hereby incorporated by reference in its entirety.

### FIELD OF THE INVENTION

The invention relates to naphthalates and other polyester-based resins, preforms, and containers, in monolayer and multilayer constructions, for packaging food and beverages such as carbonated soft drinks, beer, and juices.

### BACKGROUND OF THE INVENTION

Modern food and beverage packaging has seen the replacement of glass with less fragile materials, such as synthetic polymers. However, the versatility and performance of glass has been difficult to match, particularly with respect to product delivery in an aseptic state, clarity, product visibility, acceptable gas barrier properties, chemical resistance, and tunnel pasteurization, for example.

The development of a clear, plastic, cost effective consumer package for small carbonated and oxygen-sensitive beverages and food has long been the goal for researchers in plastic and polyethylene terephthalate (PET) packaging. Although PET bottles are already used for carbonated soft drinks (CSDs), they do not meet the stringent requirements of oxygen and carbon dioxide permeation for beer packaging and other products that require higher barriers. CSD and sparkling water producers continue to search for a resin that will provide a shelf life in the range of 18-24 weeks, compared to the only 8-12 weeks achieved for current CSD bottles.

Several polymers and copolymers with barrier additives and built-in oxygen scavengers have been used in making containers to attempt to satisfy the gas permeation requirements for beer and other sensitive beverages, but a satisfactory solution has not been found. Multilayer containers that have gas and UV barriers are still unsatisfactory for products like beer, which requires a high barrier performance from the containers to maintain the flavor, smell, carbonation, texture, and the like. For example, only 1 ppm of oxygen permeation and 15% maximum carbonation loss over 120 days is allowed. Currently available PET bottles do not meet these requirements. Moreover, monolayer PET bottles and containers are unable to survive tunnel pasteurization temperatures above 60° C. for 20 minutes at more than 10 bar pressure of CO₂, which is required for packaging beer. Beer containers are also now required to meet stringent recycling criteria in order to mix with existing recycling streams.

Researchers have sought to use more than one polymer in a container and optimize delivery systems for specific performance needs. Multilayer structures, polymer blends, and coatings coupled with oxygen scavengers that have been used fall into two main categories: a) a blown PET container, coated inside or outside, with a barrier material, such as epoxy amine, silicon oxide, or PVDC, usually applied after the container is blown; and b) a multilayer package, containing special gas barrier/oxygen scavenging layers, such as nylon, MXD6 or EVOH, is co-injection molded and blown into a container. Final containers, sometimes with up to seven layers, with one or more of the layers either acting as a physical barrier against gas permeation or as a chemically active scavenger against oxygen, have also been discussed in literature. However, unlike EVOH, nylon itself does not improve PET oxygen barrier performance, but is used as an carrier for oxygen scavenging materials and passive barrier enhancers such as nano composite clays.

A layer of EVOH or MXD6 may be sandwiched between two layers of PET. This method is used for the production of beer bottles in order to achieve some of the properties of glass bottles. However, in multilayer packaging articles, EVOH layers frequently delaminate from adjacent layers due to the incompatibility of the polymers and poor adhesion between them. Multilayers therefore typically require the use of an adhesive or tie-layer. Such adhesives or tie-layers typically do not add any other value to the package. Nylon however helps in binding EVOH, for example. While multilayer PET for beer is still in its infancy, the technology is already used in at least twenty branded products in the European market.

U.S. Pat. Nos. 6,217,818; 5,628,957; 5,651,933; 5,695,710; and 5,804,016 disclose methods for making multilayer preforms with an outer PEN layer suitable for a pasteurizable beer container. However, the PEN used has a higher Tg and slower crystallization rate, neither of which are optimal for bonding of layers, barrier strength, or thermal stability.

Continental PET technologies are also described in U.S. Pat. Nos. 6,756,444; 6,610,234; and 6,656,993, International Patent Application No. W09938914, and U.S. Patent Publication No. 2004043172, which describe a semi-aromatic and aliphatic mixture of polyamide copolymers as oxygen scavengers incorporated into multilayer containers for beer and juice.

JP Patent No. 2001062975 discloses a multilayer beer bottle with high oxygen and carbon dioxide gas barrier properties that uses two or more barrier resins and a structural material resins in three or more layers.

International Patent Application No. WO9812127 discloses multilayer bottles made of oxygen absorbing copolyester for beer applications.

U.S. Patent Publication No. 2005164021 discloses a resin composition comprising a saponified EVA copolymer and a substituted 9,10-anthraquinone in a multilayer structure for packaging foods, including beer.

U.S. Pat. No. 6,391,449 discloses Nano-N-MXD6 (M9) as an improved multi-gas barrier resin for multilayer bottle applications.

In all these monolayer and multilayer bottle applications, the barrier material is an additive that offers significant permeation resistance to gases like carbon dioxide and oxygen at high additive levels but is not fully compatible with a polyester like PET. Another limitation of multilayer containers with the nylon, EVOH, and even PEN coatings is that they cannot be recycled economically. Segregation costs are prohibitive and, if allowed to remain in the recycling stream even in trace amounts, the PET could be degraded to an unacceptable level. Even a polyester like PEN is not compatible with PET in more than trace amounts. In the absence of a market for recycling, such plastic beer bottles would not meet recycling criteria. Curbside segregation also does not solve the problem, as the beer container can not be put back in the recycling stream even for multilayer containers of beer due to the high cost of recovery and disposal of non-PET material. Of course, much of the recycled PET from these barrier containers is recycled into low end applications like fibers and strappings.

Barrier materials such as nylon and EVOH are not conducive to bottle recycling; even for fiber recycling segregation of these containers is expensive and not viable. U.S. Pat. No. 6,548,133 describes a three layer PET multilayer package having 100% Post Consumer Recycled PET (PCRPET; i.e., used PET bottles) as the core layer, with the outer layer composed of PET of high IV (above 0.84 dl/g). Preforming and stretch blow molding (SBM) require special technologies and in the absence of a speciality polyester fortified with a naphthalate, it may at best meet the lower end of the beverage packaging segments for even CSDs.

U.S. Pat. No. 6,749,785 discloses multilayer structures of PTN and co-polyesters such as PET, cyclohexane dimethanol (CHDM), and isophthalic acid (IPA), etc., for applications in co-extruded films and co-injection molded preforms and SBM containers.

The injection molding of multilayer preforms using PTN homo-polymers and/or their co-polyesters and further stretch blow molding them into containers has been done using conventional equipment and processes. However, the prior art does not address the need for a special naphthalate polymer that provides global and specific migration of degradation by-products, wider and optimum process windows, thermal stability for crystallinity, the ability to withstand tunnel pasteurization temperatures of between 60° C. and 70° C. for 20 to 30 minutes, and technology for hot filling and recycling, etc., and the avoidance of tie layers.

For example, the available naphthalate co-polyester polymers for monolayer and multilayer containers do not meet critical requirements such as low acrolein or other by-products, nor do they provide a wider processing window or optimum barrier and mechanical properties. Other multilayer preforms and containers contain non-polyester core or inner layers such as nylon and EVOH and although they may provide clarity, low oxygen permeation, and high CO₂ retention, they suffer from delamination due to poor interlayer adhesion, bursting during tunnel pasteurization due to poor thermal stability and low burst strength, are not compatible with PET recycling, and provide limiting processing and storage of preforms due to humidity issues.

### SUMMARY OF THE INVENTION

The invention provides compositions and methods for making PET co-polyester resins alloyed with naphthalates or other polyester resins by a unique polymerization process using catalysts and additives to obtain excellent thermal stability, a wider processing window in downstream processing, negligible to non-detectable levels of degradation by-products such as acrolein, and optimum crystallinity and barrier strength. The compositions of the invention meet the requirements of monolayer preforms and containers and middle, inner, outer and/or other layers of a multilayer preform or container for high end packaging applications.

In one aspect, the invention provides polymers comprising polyethylene terephthalate (PET) and polytrimethylene naphthalate (PTN) or polybutylene naphthalate (PBN). In an embodiment, the polymers are about 75% PET and about 25% PTN or PBN, or combinations thereof. In another embodiment, the polymers are about 75% PET, about 20% PTN, PBN, or combinations thereof, and about 5% polybutylene terephthalate (PBT), isophthalic acid (IPA), or combinations thereof.

The invention also provides core (i.e., middle) layers for use in a multilayer composition. In an embodiment, the core polymer is about 100% PTN, PBN, or combinations thereof. In another embodiment, the core layer is about 85% PTN, PBN, or combinations thereof, and about 15% PBT, PET, IPA, or combinations thereof. In yet another embodiment, the core layer is about 85% PTN and about 15% PBN. In still another embodiment, the core layer is about 85% PBN and about 15% PET, IPA, or combinations thereof. In yet another embodiment, the core layer is about 85% PET and about 15% PTN, PBN, PBT, or combinations thereof.

The invention also provides inner and outer layers for use in a multilayer composition. In an embodiment, the inner or outer layer is about 85% PET and about 15% PTN, PBN, or combinations thereof. In another embodiment, the 85% PET comprises about 10 to about 20% Post Consumer Recycled PET (PCRPET). For example, the PCRPET is combined with the PET through in situ glycolysis and polymerization of purified terephthalic acid (PTA) and monoethylene glycol (MEG) in the same reactor.

In certain embodiments, a number of additives are included in the polymers of the invention. In an embodiment, the inner or outer layer further comprises at least one of a CO₂ barrier, an oxygen scavenger, a nucleating agent, a thermal stabilizer, and a clear fast heat additive.

The CO₂ barrier may be PTN, PBN, or combinations thereof.

The oxygen scavenger may be a commercial product such as Amosorb®, or a metallic particle like iron, copper, cobalt, or combinations thereof.

The nucleating agent may be nano clay, nano silica, micronized zinc oxide, micronized sodium benzoate, sorbitol, ethylene acrylic acid sodium ionomer, sodium salicylate, talc, or combinations thereof.

The thermal stabilizer may be orthophosphoric acid (OPA), tetraethyl phosphonium acetate (TEPA), trimethyl phosphite, phosphoric acid, or combinations thereof.

The clear fast heat additive may be tungsten metal powder, tungsten oxide, tungsten trioxide, tungsten carbide, or combinations thereof.

In another aspect, the invention provides monolayer and multi layer containers, comprising the above polymers. Multilayer containers contain at least one of an inner layer and an outer layer. In an embodiment of a multilayer container, the core layer comprises a thickness of about 4% to about 20% of a total thickness of the layers. For example, the core layer comprises a thickness of about 20 microns and the inner and/or outer layer comprises a thickness of about 200 microns. In an embodiment, the containers of the invention can be tunnel pasteurized at between about 60 ° C. and about 70 ° C. and hot filled at between about 85 ° C. and about 100 ° C. The containers can be bottles, for example, beer or CSD bottles.

In another aspect, the invention provides methods for producing a PTN polymer, the method comprising the steps of (a) adding NDC and PDO or BDO to an esterification reactor; (b) adding an esterification catalyst; (c) adding at least one of a clear fast reheat additive, a nano compound, a tin compound, and a nucleating agent and incubating to form a prepolymer; (d) transferring the prepolymer to a poly reactor; (e) adding at least one of a polymerization catalyst and a heat stabilizer and incubating at about 230° C. to about 270° C.; (f) adding at least one of an end capping agent, an acrolein suppressor, a tetrahydrofuran (THF) suppressor, PBN, thereby creating a polymer melt; and (g) extruding the polymer melt under nitrogen pressure to form pellets. In an embodiment, the method further comprises vacuum distillation during steps (c) and (e).

Suitable esterification catalysts include manganese acetate, cobalt acetate, calcium acetate, zinc acetate, and combinations thereof.

Suitable clear fast reheat additives include tungsten metal powder, tungsten oxide, tungsten trioxide, tungsten carbide, and combinations thereof.

Suitable nanocompounds include nano clay, nano silica, and combinations thereof.

Suitable nucleating agents include nano clay, nano silica, micronized zinc oxide, micronized sodium benzoate, sorbitol, ethylene acrylic acid sodium ionomer, sodium salicylates, talc, and combinations thereof.

Suitable polymerization catalysts include tin oxide, tetrabutyl titanate (TnBT), antimony trioxide, butylstannoic acid, and combinations thereof.

Suitable heat stabilizers are orthophosphoric acid (OPA), tetraethyl phosphonium acetate (TEPA), trimethyl phosphite, phosphoric acid, and combinations thereof.

A suitable acrolein suppressor is ethylene carbonate.

Suitable THF suppressors include sodium methoxide, sodium phosphate, sodium citrate, and combinations thereof.

In an embodiment of the methods of the invention, the polymers are further subjected to SSP, for example, (h) precrystallising the pellets at 140° C. in a fluid bed precrystallizer followed by cooling; (i) transferring the chips to a tumbling dryer and increasing the temperature to about 35° C. to about 180° C. with nitrogen bleeding and maintaining the temperature for about 5 to about 8 hours; () maintaining the temperature at about 180° C. for about 3 hours while pressurized with nitrogen at 0.5 bar g; and (k) releasing the pressure and evacuating the dryer to a pressure level of 1.0 mbar.

### DETAILED DESCRIPTION OF THE INVENTION

In one aspect, the invention provides compositions of polyester resins for a) monolayer preforms and containers and b) core and other different layer(s) (e.g., inner and outer) of multilayer preforms and containers, without the need for adhesives or tie layers. Both monolayer and multilayer containers meet all the respective gas barrier and other designated barrier requirements, can be tunnel pasteurized at between about 60° C. and about 70° C. for about 20 to about 30 minutes, and can be hot filled at between about 85° C. to about 100° C. The multilayer containers of the invention are free of delamination problems such as those seen for non-polyester multilayer structures described in the art.

In an embodiment, the present invention provides compositions of polyester based resins, predominantly composed of polyethylene terephthalate (PET) and poly trimethylene naphthalate (PTN) or poly butylene naphthalate (PBN), as well as monolayer and multilayer preforms and containers comprised thereof.

For monolayer beer containers, about 25% PTN or PBN or about 20% of an alloy of PTN or PBN with about 5% poly butylene terephthalate (PBT) or isophthalic acid (IPA), or an equal combination thereof, is alloyed with about 75% PET to create uniform polymers that provide sufficient thermal stability and burst strength for withstanding tunnel pasteurization cycles in beer bottle manufacturing. The polymers also act as a secondary barrier layer for CO₂ in support of a core layer in a multilayer container. For CSD and less stringent beer applications, the use of naphthalate in outer and inner layers can be avoided by using appropriate barrier additives with PET or co-polyesters for the polymer used in inner layers.

In multilayer containers, the core (i.e., middle) layer comprises 100% PTN or PBN or an alloy with 15% PBT or PET or IPA. PTN or PBN is produced preferably through reaction polymerization of NDC with PDO or BDO, respectively, containing other additives or co-polyesters as required, according to standard methods. This composition serves as a core gas barrier layer impervious to CO₂ egress and O₂ ingress, as well as a UV barrier up to 360 nm. In an embodiment, for CSD and beer containers, the resin composition is preferably an alloy (i.e., blend) of 85% PTN and 15% PBN, the latter immensely helping in enhancement of crystallization without impairing clarity. The resin composition can also be an alloy of about 85% PBN with about 15% PET or IPA, wherein the melt viscosity of the alloy ideally helps injection molding of the preforms at lower temperatures. The O₂ barrier strength is further fortified by dosing a proven oxygen scavenger master batch in the multilayer injection molding machine with the carrier being 100% PTN or PBN or an alloy of 85% PET with 15% PTN or PBN or PBT.

In an embodiment, the outer and inner supporting layer(s) are composed of at least about 85% PET, alloyed with a maximum of about 15% PTN or PBN, for stringent applications like beer. In an embodiment, the outer and inner layer(s) may be fortified with a CO₂ barrier additive in the resin alloy both for beer and CSD uses to impart thermal stability and burst strength for withstanding beer tunnel pasteurization cycles. It also acts as a secondary barrier layer for CO₂ in support of the core layer of PTN or PBN in combination with PET or PBT or IPA or their alloys. An oxygen scavenger additive may also be added to the outer and/or inner layers, for example, through a master batch of the base resin itself, during preform manufacture, which delivers a secondary oxygen barrier protection layer in support of the core layer. While PET with a naphthalate alloy and O₂ scavenger is a preferred composition for beer containers requiring long shelf life, naphthalate usage may be substituted with 20% PCRPET (Post Consumer Recycled PET) for CSD in outer and inner layers, fortified with appropriate barrier additives, for example, wherein the PCRPET is combined through in situ glycolysis and polymerization of purified terephthalic acid (PTA) and monoethylene glycol (MEG) in the same reactor. Use of PCRPET for beer containers is restricted to about 10-20% in the outer layer, within the 85% PET component, produced again through in situ glycolysis with virgin polymer.

In an embodiment, the three layers (inner, core, and outer) are 200, 20, and 200 microns thick, respectively, for a 20.5 g (380 ml container). In other words, the core layer thickness ranges from about 4% to about 12%, preferably about 4%, of the total thickness of the three layers.

The polyesters in all the layers are modified with appropriate additives to yield faster crystallizing properties for increasing the thermal stability of the container during tunnel pasteurization, where required. In an embodiment, nucleating agents are added to the layers to yield faster crystallizing properties. To improve the thermal stability, special additives are added to minimize the -COOH end groups and acrolein or tetrahydrofuran (THF) generation in PTN and PBN polyesters, respectively. Due to the below detectable (<0.01 ppm) level of presence of acrolein and THF achieved in these manner the containers satisfy Global Migration Compliance for food contact applications from removing unknown apprehensions about Acrolein and THF. Preferably, clear fast reheat additives are also added, which improve the productivity and save energy during the bottle blowing process and provide a wider operating temperature window during the process of reheating the preforms prior to blowing, e.g., in the temperature range of about 85° C. to about 120° C. The clear fast reheat additive also helps in increasing the solid state polymerization (SSP) rate and giving resin with a better color having a high L* value. Depending on the end use these special additives are incorporated in individual or all three layers of the multilayer container.

In another aspect, the invention provides method of making compositions of polyester based resins, predominantly composed of polyethylene terephthalate (PET) and poly trimethylene naphthalate (PTN) or poly butylene naphthalate (PBN), as well as monolayer and multilayer preforms and containers comprised thereof.

The invention provides methods for producing polymers comprising the steps of (a) adding NDC and PDO or BDO to an esterification reactor; (b) adding an esterification catalyst; (c) adding at least one additive selected from the group consisting of a clear fast reheat additive, a nano compound, a tin compound, and a nucleating agent and incubating to form a prepolymer; (d) transferring the prepolymer to a poly reactor; (e) adding at least one of a polymerization catalyst and a heat stabilizer and incubating at about 230° C. to about 270° C.; (f) adding an agent selected from the group consisting of an end capping agent, an acrolein suppressor, a tetrahydrofuran (THF) suppressor, and a combination thereof, thereby creating a polymer melt; and (g) extruding the polymer melt under nitrogen pressure to form pellets.

In an embodiment, the invention provides methods for producing polymers comprising the steps of (a) adding NDC and PDO or BDO to an esterification reactor; (b) adding an esterification catalyst, a clear fast reheat additive, a nano compound, and a nucleating agent and incubating to form a prepolymer; (c) transferring the prepolymer to a poly reactor; (d) adding a polymerization catalyst and a heat stabilizer and incubating at about 230° C. to about 270° C. for about 4 hours; (e) adding an end capping agent, an acrolein suppressor, and a THF suppressor to create a polymer melt; and (f) extruding the polymer melt under nitrogen pressure to form pellets.

In another embodiment, the invention provides methods for producing PTN with 15% PBN comprising the steps of (a) adding NDC and PDO to an esterification reactor; (b) adding an esterification catalyst; (c) adding tin compound and tungsten trioxide in two equal parts, one at the start of esterification and other at the end of esterification, and incubating to form a prepolymer; (d) transferring the prepolymer to a poly reactor; (e) adding TEPA and incubating at about 230° C. to about 250° C. for about 230 minutes; (f) adding TBPA, ethylene carbonate, Nyacol®, and 15% (w/v) PBN to create a polymer melt; and (g) extruding the polymer melt under nitrogen pressure to form pellets.

In another embodiment, the invention provides methods for producing PTN with 10% PBN comprising the steps of (a) adding NDC and PDO to an esterification reactor; (b) adding an esterification catalyst; (c) adding tin compound and tungsten trioxide in two equal parts, one at the start of esterification and other at the end of esterification (d) vacuum distilling for about 30 minutes followed by atmospheric distilling for about 185 minutes; (e) transferring the prepolymer to a poly reactor; (f) adding TEPA and incubating at about 230° C. to about 260° C. for about 190 minutes; (g) adding a nucleating agent such as Nyacol® or Acyln (Honeywell, USA), and 10%(w/v) PBN to create a polymer melt; and (h) extruding the polymer melt under nitrogen pressure to form pellets.

In another embodiment, the invention provides methods for producing PTN with 7% PBN comprising the steps of (a) adding NDC and PDO to an esterification reactor; (b) adding an esterification catalyst; (c) adding tin compound and tungsten trioxide in two equal parts, one at the start of esterification and other at the end of esterification (d) vacuum distilling for about 30 minutes followed by atmospheric distilling for about 180 minutes; (e) transferring the prepolymer to a poly reactor; (f) adding TEPA and incubating at about 230° C. to about 250° C. for about 159 minutes; (g) adding 7% (w/v) PBN to create a polymer melt; and (h) extruding the polymer melt under nitrogen pressure to form pellets.

In another embodiment, the invention provides methods for producing PTN with 15% PBN comprising the steps of (a) adding NDC and PDO to an esterification reactor; (b) adding tin compound, tungsten trioxide, cobalt acetate and manganese acetate in two equal parts, one at the start of esterification and other in the middle of esterification (manganese acetate) or at the end of esterification, and incubating at about 200° C. and about 230° C. for a period of about 238 minutes (c) transferring the prepolymer to a poly reactor; (d) adding TBPA, ethylene carbonate, Nyacol®, and 15% (w/v) PBN and incubating at about 230° C. to about 245° C. for about 159 minutes to create a polymer melt; and (e) extruding the polymer melt under nitrogen pressure to form pellets.

In an embodiment, an oxygen scavenger (OS) is incorporated into one or more layers. In an embodiment, the OS is an iron based material (including micron and nano sized particles), or may comprise copper or cobalt. In another embodiment, the OS is polymer based, such as Amosorb® (Colormatrix, Ohio, USA). The OS is dosed into the outer and inner layers preferably through a master batch of the base resin during extrusion of the preform manufacturing by injection molding. The OS level is in the range of about 1000 to about 6000 ppm, preferably between about 2500 and about 3500 ppm.

Suitable esterification catalysts include manganese acetate, cobalt acetate, calcium acetate, zinc acetate, and combinations thereof. Esterification catalysts are added to a range of about 20 to about 500 ppm, preferably about 250 ppm.

Suitable clear fast reheat additives include tungsten metal powder, tungsten oxide, tungsten trioxide, tungsten carbide, and combinations thereof. Clear fast reheat additives are added to a range of about 5 to about 30 ppm, preferably about 20 ppm.

Suitable nanocompounds include nano clay, nano silica, and combinations thereof. Nano compounds are added to a range of about 1000 to about 20000 ppm, preferably about 10,000 ppm.

Suitable nucleating agents include nano clay, nano silica (such as Nyacol®; Nanotechnologies Inc., Austin, Tex., USA), micronized zinc oxide, micronized sodium benzoate, sorbitol, ethylene acrylic acid sodium ionomer (such as Aclyn®; Honeywell, USA), sodium salicylates, talc, and combinations thereof. Nucleating agents are added in the range of about 0 to about 10,000 ppm, preferably in the range of about 20 to about 5000 ppm, most preferably in the range of about 150 to about 5000 ppm. In an embodiment, Nyacol® is added to about 3,500 ppm.

Suitable polymerization catalysts include organic tin compounds in the form of their oxides, such as tin oxide comprising about 56.8% tin. By using the organic tin based compounds, instead of the conventional antimony and titanium, etc., superior color is obtained in the resin. Alternatively, the polymerization catalyst is an antimony or titanium compound, such as tetrabutyl titanate (TnBT) and antimony trioxide, and combinations thereof. In another embodiment, the polymerization catalyst is butylstannoic acid. Polymerization catalysts are added to a range of about 10 to about 300 ppm, preferably about 200 ppm.

Suitable heat stabilizers include phosphorous based compounds such as orthophosphoric acid (OPA), tetraethyl phosphonium acetate (TEPA), trimethyl phosphite, phosphoric acid, and combinations thereof. Heat stabilizers are added to deactivate the esterification catalysts after the completion of the ester interchange process, such that the total phosphorous content is in the range of about 10 to about 300 ppm, in the range of about 20 to about 150 ppm. In an embodiment, TEPA is added to about 70 ppm.

Suitable end capping agents include tetrabutylphosphonium acetate (TBPA). In an embodiment, TBPA is added to about 25 ppm.

A suitable acrolein suppressor is ethylene carbonate. An acrolein suppressor is added to the range of about 10 to about 10,000 ppm, preferably about 20 to about 6000 ppm, or about 0.5%. In an embodiment, an acrolein suppressor is added to about 5,000 ppm.

Suitable THF suppressors include sodium methoxide, sodium phosphate, sodium citrate, and a combination thereof. THF suppressors are added to the range of about 50 to about 2500 ppm, preferably in the range of about 10 to about 100 ppm, or about 0.005%. In an embodiment, THF suppressors are added into the poly reactor after completion of polymerization through a catalyst addition pot under vacuum keeping the isolation valve closed.

Esterification is carried out between about 200° C. and about 245° C., preferably at about 220° C., for a period of about 3.5-6 hours and methanol is collected as a byproduct. Other known conventional processes utilize esterification temperatures of up to 250° C. Esterification is carried out at about 1050 mbar. The lower processing temperatures result in superior thermal stability and a lower number of —COOH end groups, i.e., about 3 instead of the normal high of about 15 meq/kg.

Post esterification and prepolymerization (in the case of a three reactor system) is carried out at about 500 to about 250 mbar for about 50 minutes. The post esterification and prepolymerization takes place in a prepolyreactor in a three reactor system. In the case of a two reactor system the esterification is completed in an esterification reactor and the prepolymerization and polycondensation takes place in a polycondensation reactor or an autoclave.

Polymerization is conducted at very low pressure (less than about 1 mm Hg absolute) in the temperature range of about 230° C. to about 270° C., but preferably at about 240° C., with a process time of about 2 to 5 hours. Conventional processes use a maximum of 280° C., which is not desirable for a good quality resin of good color.

Crystallization temperatures are in the range of about 120° C. to about 180° C., which occurs in the multilayer containers when the corresponding preforms are stretch blow molded. The times will be only in the order of seconds and the pressure will be in the range of about 10 to about 30 bar.

In an embodiment, the resins corresponding to the three layers are coextruded using a co-injection moulding to preforms followed by stretch blow molding to bottles.

In an embodiment, the injection molding of the polymers to monolayer preforms is carried out using a Husky multi cavity injection molding machine and multilayer preforms are made using a multilayer injection molding machine that employs a multiple-plastic stream co-extruder. The enhanced crystallinity imparted to the polymers of the invention enables a flexible and wider operating window, e.g., below 90° C., in the preform reheating prior to stretch blow molding.

The monolayer and multilayer containers are stretch blown by conventional SBM machines like a 2 cavity stretch blowing machine (Shyam Plastics, India) or a Sidel-SBO1 stretch blowing machine (Sidel India Ltd., Mumbai, India). The multilayer containers deliver excellent performance without delamination because the three layers of polyesters have remarkable adhesion properties due to compatible Tg and Tm. The multilayer container produced from the 3 different layers of polymers described as per the present invention meets all the criterion for CSD packaging and more importantly, beer packaging in terms of the requisite CO₂, O₂ and UV barrier performance and additionally provides containers which can be subjected to tunnel Pasteurization at about 60° C. to about 63° C. for 20 minutes with beer filled at about 3° C. to about 4° C. and GV of about 2.75 to about 3 bar CO₂ pressure.

Further, the preforms can be stored without the need for special protection against humidity and limitation of shelf life.

The containers of the invention possess excellent adhesion of layers free from delamination. The containers are also 100% recyclable with the known recycling technologies.

It is envisaged that the multilayer containers in accordance with this invention can also have more than 3 layers and can also be extrapolated with same grade of PET-PTN, PET-PBN or PBT or IPA or other materials and their combination with additives dosed as master batch of respective polymer layer in order to achieve customized packaging needs of additional barrier systems for flavor, chemical resistance and water vapor, etc., free from interference of other additives.

The invention typically provides a unique method of formulating a suitable polymer for each one of the layers of a multilayer film or bottle as a flexible package, preferably consisting of three layers:

1) The polymer for the ‘inner layer’ is a polyester resin, which is an alloy of PET at 85% minimum, with its copolyesters at 15% maximum for CSD and an alloy of PET at 85% minimum with PTN or PBN at 15% maximum for beer containers. Minimum composition PET:PTN or PET:PBN is 75 to 95:25 to 5.

2) The polymer for the ‘core or middle layer’ is a minimum of 85% PTN or PBN with balance 15% maximum comprising PBT or PET or IPA.

3) The polymer for the outer layer is again a polyester resin, which is an alloy of PET at 85% minimum, with its copolyesters at 15% maximum for CSD and an alloy of PET at 85% minimum with PTN or PBN at 15% maximum for beer containers.

4) The PET at 85% minimum in the inner and outer layers are designed to contain preferably a minimum of 10% PCRPET for beer and a minimum of 20% for CSD applications.

5) The outer, core, and inner layers will have provision for dosing with a proven oxygen scavenger alloy in a carrier resin like a PTN or PET-PTN or PET-PBN alloy for augmenting oxygen barrier and imparting thermal stability/burst strength to withstand tunnel pasteurization.

In another aspect, the invention provides a procedure for recycling the polyester monolayer and multilayer containers of the invention using conventional technologies, in existing PET recycling streams.

Practice of the invention will be still more fully understood from the following examples, which are presented herein for illustration only and should not be construed as limiting the invention in any way.

### EXEMPLIFICATION

### Example 1

### Manufacture of PTN

About 9.5 kg of naphthalene dicarboxylic acid dimethyl ester (NDC) and 4.2 kg of 1,3-Propane Diol (PDO) are placed in an esterification reactor at a molar ratio (NDC:PDO) of about 1:1.25. 1.85 g of manganese acetate (40 ppm as Mn) and 1.7 g cobalt acetate (40 ppm as Co) are added as esterification catalysts. The esterifying step is carried out between about 200° C. and about 245° C. for a period of about 5 to about 6 hours. Methanol is removed as a byproduct. The prepolymer formed is transferred via a 20 micron filter to a polyreactor. About 3.5g polymerization catalyst butylstannoic acid is added (200 ppm as Sn) and subsequently phosphorous based thermal stabilizers such as 0.7 g orthophosphoric acid (OPA) and 1.4 g triethylphophonoacetate (TEPA) are added such that the total phosphorus content is 40 ppm (e.g., 20 ppm each as P). The polymerizing step is conducted at very low pressure (e.g., less than about I mm Hg absolute) at about 240° C. to about 270° C. with a process time of about 4 hours. After reaching the required molecular weight, as indicated by intrinsic viscosity (IV), the end capping additives TBPA and ethylene carbonate are added, about 0.5 g (50 ppm) and about 50 g (0.5% w/w), respectively, and allowed to interact thoroughly with the melt with a pressure of about I mbar for 30 minutes. The amorphous PTN polymer melt is extruded under nitrogen pressure and collected as pellets.

### Example 2

### Manufacture of PBN

Dimethyl 2,6-naphthalene dicarboxylate (NDC)/1,4-butane diol (BDO) paste comprising about 9.0 kg of NDC and about 5.3 kg of BDO is charged to an esterification reactor, in 1:1.4 molar ratio. The paste also contains 40 ppm (as Ti) of tetra butyl titanate (TnBT, 0.56 g) as a catalyst. Esterification is carried out at about 200 to about 245° C. under a pressure of about 2.2 bar(g). At this stage the polymer-melt is stabilized with 3.6 g TEPA (50 ppm as P) and 1.7 g OPA (50 ppm). After esterification, the prepolymer formed is filtered through a 20 micron filter and transferred to a polyreactor. The prepolymer is polymerized by gradually reducing the pressure to about 5-15 mbar and increasing the temperature to about 250° C. Toward the end of the process, the pressure is further reduced to <1.0 mbar (abs) and the temperature is increased to about 250-255° C. After the requisite IV is reached as indicated by the kilowatt of the agitator, the polymer melt is extruded under nitrogen pressure and converted into amorphous pellets. These amorphous pellets are subjected to pre-crystallization and solid sate polymerization to increase the IV to 0.72-1.20 dL/g.

### Example 3

### Naphthalate Based Barrier Resins

A polymer process comprising a tin based catalyst, lower esterification and polycondensation temperatures, and additives that minimize the generation of acrolein and THF is provided.

About 9.5 kg of NDC and about 4.2 kg of PDO or BDO are added to an esterification reactor while maintaining the molar ratio NDC:PDO or NDC:BDO at about 1:1.43. 1.85 g of manganese acetate (40 ppm as Mn) and 1.7 g of cobalt acetate (40 ppm as Co) are added as esterification catalysts. About 0.1 g of clear fast reheat additive tungsten trioxide (about 10 ppm), 100 g of a nano compound such as nano clay or nano silica (about 10,000 ppm), and a nucleating agent such as 1 g each of sodium acetate and sodium benzoate (about 200 ppm together) are added. Esterification is carried out between about 200° C. and about 245° C., preferably at about 220° C., for a period of about 6 hours and methanol is collected as a byproduct. The prepolymer formed is transferred to a poly reactor through a 20 micron filter. About 3.5 g of a polymerization catalyst consisting of a tin compound in the form of its oxide, such as tin oxide comprising 56.8% tin, is added to about 200 ppm as Sn. About 1.4 g of a phosphorous based heat stabilizer such as orthophosphoric acid (OPA) is added such that the phosphorous content is about 40 ppm as P. Polymerization is conducted at very low pressure (<1 mm Hg absolute) in the temperature range of about 230° C. to about 270° C., but preferably at about 240° C., with a process time of about 4 hours.

After reaching the required kilowatt of the reactor agitator, about 0.5 g of an end-capping agent such as TBPA (about 50 ppm), about 50 g of an acrolein suppressor such as ethylene carbonate (about 0.5%), and about 5 g of a THF suppressor such as sodium methoxide or phosphate or citrate (about 0.005%), are added and allowed to interact thoroughly with the melt. The amorphous polymer melt is extruded under nitrogen pressure and collected as pellets. Table I shows lists the characteristics of the amorphous PTN and PBN polymers.

TABLE I

| | | | VALUE | |
|---|---|---|---|---|
| Sl. No. | PARAMETER | UNIT | PTN | PBN |
| 1. | Intrinsic Viscosity | dL/g | 0.38 | 0.73 |
| 2. | Carboxyl Number | meq/kg | 2 | 5 |
| 3. | Dipropylene Glycol | Wt. % | 0.08 | — |
| 4. | Acrolein or THF | ppm | 3.5 | 5.1 |
| 5. | L* amorphous/crystalline | CIE | 55/81 | 80/82 |
| 6. | a* | CIE | −1.0/−1.7 | −2.4/−1.5 |
| 7. | b* | CIE | −1.8/−1.1 | −0.9/−0.1 |
| 8. | T_{g} | ° C. | 80.7 | — |
| 9. | Tₘ | ° C. | 205 | 241 |
| 10. | T_{ch} | ° C. | 167 | — |

Note:
T_{g} - glass transition temperature;
Tₘ - melting point;
T_{ch} - cold crystallization temperature in the second heating cycle.
T_{g}, Tₘ, and T_{ch} obtained by DSC thermal analysis measurements.

The amorphous PTN and PBN are upgraded to higher I.V. by solid state polymerization (SSP), which involves a procedure different from the usual procedure followed for PET SSP. The amorphous resin is precrystallised at 140° C. in a fluid bed precrystallizer and cooled. The cooled precrystallized PTN or PBN chips are transferred to a tumbling dryer and the chip temperature is increased to about 35 to about 180° C. with nitrogen bleeding and maintained for about 5 to about 8 hours at this temperature. Subsequently the temperature is held at about 180° C. and pressurized with nitrogen at 0.5 bar g and maintained for about 3 hours under these conditions. The pressure is released and the dryer is evacuated to a pressure level of 1.0 mbar. Properties of the PTN and PBN after SSP are shown in Tables II and III, respectively.

TABLE II

| | I.V. | Acrolein | L* | a* | b* | Tg | Tm |
|---|---|---|---|---|---|---|---|
| PTN | (dL/g) | (ppm) | (CIE) | (CIE) | (CIE) | (° C.) | (° C.) |
| Amorphous | 0.432 | 3.4 | 57 | −0.8 | −1.6 | 80.7 | 205.9 |
| Feed Resin | | | | | | | |
| Final SSP | 0.590- | Nil (below | 73 | −1.5 | −1.0 | 79.3 | 202.5 |
| Resin | 0.800 | detectable | | | | | |
| | | limit) | | | | | |

TABLE III

| | I.V. | THF | L* | a* | b* | Tg | Tm |
|---|---|---|---|---|---|---|---|
| PBN | (dL/g) | (ppm) | (CIE) | (CIE) | (CIE) | (° C.) | (° C.) |
| Amorphous | 0.734 | 5.2 | 81.8 | −2.4 | −0.9 | — | 241 |
| Feed Resin | | | | | | | |
| Final SSP | 0.840 | <0.01 | 82.3 | −1.5 | −0.1 | — | 241 |
| Resin | | | | | | | |

Similar results are obtained when PTN or PBN are partly substituted by PBT or other polyesters and their copolyesters.

### Example 4

### Properties of Naphthalate Based Barrier Resin Monolayer Containers

Table IV gives a comparison of the barrier properties of PET and PEN monolayer bottles versus bottles made with PTN and PBN and their alloys.

TABLE IV

| | Permeation or | | | | | | |
|---|---|---|---|---|---|---|---|
| | Gas | | | | | | |
| | Transmission, | | | | | | |
| | cc · mil/100 | | | | | | |
| Sl. | in² · atm · day at | | | | | | PET/ |
| No. | 35° C. | PET | PEN | PTN | PBN | PET/PTN | PBN |
| 1 | Oxygen | 12 | 6 | 2 | 15 | 4 | 3 |
| 2 | Carbon | 65 | 12 | 4 | 9 | 15 | 13 |
| | Dioxide | | | | | | |

The above data indicated that PTN, PBN or PET/PTN/PBN alloys have excellent barrier properties against oxygen and carbon dioxide.

### Example 5

### Properties of Naphthalate Based Barrier Resin Multilayer Containers

20.5 g (380 ml) three layer beer bottle preforms are co-injected and subsequently stretch blow molded at between about 85° C. and about 120° C. to make a bottle having 200/20/200 micron layers. The compositions of the three layers are given in the Table V along with the carbon dioxide (CO₂) loss and oxygen (O₂) ingress measurements. The permeability of these gases is measured in the multilayer bottles by GMS gas measuring equipment for CO₂ and Orbisphere for O₂ analysis. Table V also gives the permeation values for a monolayer PET bottle of the same weight and size for comparison.

TABLE V

| | | | | CO₂ | |
|---|---|---|---|---|---|
| | Resin Composition | | | Loss | |
| Sr. | Outer Layer | Core Layer | | % in 8 | O₂ Ingress |
| No. | (dL/g) | (dL/g) | Inner Layer | weeks | (ml/pkg/day) |
| 1. | 80% PET and | 94% PTN | 92% PET and 8% PTN as | 7.0 | 0.0097 |
| | 20% PCR PET | Copolyester | alloy/blend with 0.3% | | |
| | (I.V. ˜0.84) | (I.V.˜0.72) | oxygen scavenger | | |
| 2. | 80% PET and | 94% PTN | 92% PET and 8% PBN | 6.2 | 0.0072 |
| | 20% PCR PET | Copolyester | as alloy/blend with 0.3% | | |
| | (I.V. ˜0.84) | (I.V. ˜0.72) | oxygen scavenger | | |
| 3. | 80% PET and | 94% PTN | 92% PET and 8% | 6.7 | 0.0082 |
| | 20% PCR PET | Copolyester | PBN/PTN as alloy/blend | | |
| | (I.V. ˜0.84) | (I.V.˜0.72) | with 0.3% oxygen | | |
| | | | scavenger | | |

| | | | |
|---|---|---|---|
| 4. | Monolayer bottle of 100% PET | 25.2 | 0.032 |

The loss of CO₂ and ingress of O₂ are well within the requirement for a container filled with an alcoholic beverage, such as beer after pasteurization at 60° C. for 20 minutes.

### Example 6

### Pasteurization Tests of Naphthalate Based Barrier Resin—Mono & Multilayer Containers

A laboratory set up designed to simulate tunnel pasteurization conditions in which the bottles are blown in a 2 cavity or 1 cavity machine and filled with water, carbonated, and CO₂ pressurized bottles are subjected to 63° C. for 20 minutes after the contents reach 63° C. The bottles are then taken out and kept in an ambient temperature water bath for 45 minutes. The bottles are then examined for any deformation or shape change and also for any leaks from the cap. The carbonation loss if the bottles is checked using a gas volume tester with a piercing device. Test results of tunnel pasteurization of the monolayer PET/PTN (92/8) alloy beer bottles filled with water and carbonated are given in Table VI. Different bottle sizes with 28 PCO closures and crown caps were tested and the bottle characteristics before and after pasteurization were compared.

TABLE VI
PET-PTN ALLOY BARRIER RESIN WITH OXYGEN SCAVENGER

| | Bottle | | | | | | | |
|---|---|---|---|---|---|---|---|---|
| Volume | Wt. | | Bottle | Pr. | Temp. | | Bottle | |
| (ml) | (g) | Neck Finish | No. | (Psi) | (° C.) | G.V. | Shape | Remarks |
| 650 | 30 | 28 PCO | 1 | 50 | 25 | 3.2 | * | Before |
| | | | 2 | 47 | 26 | 3.0 | * | Pasteurization |
| | | | 3 | 48 | 25 | 3.5 | OK | After |
| | | | 4 | 50 | 28 | 3.2 | OK | Pasteurization |
| | | | 5 | Kept for Visual | | | OK | |
| | | | | Inspection | | | | |
| 650 | 30 | CROWN | 1 | 48 | 25 | 3.2 | * | Before |
| | | | 2 | 46 | 25 | 3.4 | * | Pasteurization |
| | | | 3 | 50 | 25 | 3.5 | OK | After |
| | | | 4 | 47 | 25 | 3.0 | OK | Pasteurization |
| | | | 5 | Kept for Visual | | | OK | |
| | | | | Inspection | | | | |
| 500 | 28 | 28 PCO | 1 | 46 | 25 | 3.8 | * | Before |
| | | | 2 | 48 | 25 | 3.2 | * | Pasteurization |
| | | | 3 | 45 | 26 | 3.0 | OK | After |
| | | | 4 | 40 | 25 | 2.9 | OK | Pasteurization |
| | | | 5 | | | | | |
| 500 | 28 | CROWN | 1 | 42 | 26 | 5 | * | Before |
| | | | 2 | 44 | 25 | 4.7 | * | Pasteurization |
| | | | 3 | 40 | 25 | 2.8 | OK | After |
| | | | 4 | 38 | 25 | 2.7 | OK | Pasteurization |
| | | | 5 | Kept for Visual | | | OK | |
| | | | | Inspection | | | | |
| 330 | 24 | 28 PCO | 1 | 50 | 26 | 4.9 | * | Before |
| | | | 2 | 47 | 27 | 5.3 | * | Pasteurization |
| | | | 3 | 50 | 27 | 2.9 | OK | After |
| | | | 4 | 48 | 27 | 3.3 | OK | Pasteurization |
| | | | 5 | Kept for Visual | | | OK | |
| | | | | Inspection | | | | |
| 330 | 24 | CROWN | 1 | 47 | 26 | 5 | * | Before |
| | | | 2 | 45 | 25 | 4.7 | * | Pasteurization |
| | | | 3 | 40 | 26 | 3.0 | OK | After |
| | | | 4 | 45 | 26 | 2.9 | OK | Pasteurization |
| | | | 5 | Kept for Visual | | | OK | |
| | | | | Inspection | | | | |
| 650 | 34 | CROWN | 1 | 37 | 12 | * | * | Before |
| | | | 2 | 40 | 25 | * | * | Pasteurization |
| | | | 3 | 42 | 27 | 3.70 | OK | After |
| | | | 4 | 54 | 27 | 6.60 | OK | Pasteurization |
| | | | 5 | 42 | 27 | 5.80 | OK | |

No distortion or rocking of bottles was observed. The final dimensions of bottles were found to be acceptable.

When the experiments are repeated for multilayer containers with core layer (PTN or PBN 85% minimum) and other layers (PET 85% minimum), the tunnel pasteurization results are almost similar to that obtained with PET or PTN alloy monolayer containers.

### Example 7

### Manufacture of PTN with 15% PBN

A 1:1.4 molar ratio of NDC and PDO are charged into an esterification reactor. The esterification catalysts used are cobalt acetate (50 ppm as Co, 2.1 g) and manganese acetate (60 ppm as Mn, 2.8 g), 220 ppm of tin oxide (3.8 g) and 12 ppm of tungsten trioxide (0.12 g) are added in two equal parts, one at the start of esterification and the other at the end of esterification. The esterification is carried out between about 200° C. and about 230° C. for a period of about 230 minutes. The atmospheric distillation is carried out at about 1050 mbar for about 200 minutes and vacuum distillation at about 500 mbar for about 30 minutes, for a total of about 230 minutes. The prepolymer formed is transferred to a poly reactor. TEPA is added such that the phosphorus content is about 70 ppm (5.07 g). The polymerization is conducted at about 230° C. to about 250° C. for a period of 230 minutes. After reaching the required kilowatt of the reactor, TBPA (about 25 ppm, 0.25 g), ethylene carbonate (about 5000 ppm, 50 g), PBN (about 15 wt %, 1500) and Nyacol® (about 3500 ppm, 35 g) are added to the melt. The amorphous polymer melt is extruded under nitrogen pressure and collected as pellets.

### Example 8

### Manufacture of PTN with 10% PBN

NDC and PDO are mixed in a molar ratio of 1:1.4 in an esterification reactor. Manganese acetate (60 ppm as Mn, 2.8 g) and cobalt acetate (60 ppm as Co, 2.5 g) are added as esterification catalysts. 150 ppm of tin oxide (2.6 g) and 5 ppm of tungsten trioxide (0.05 g) are added in two equal parts, one at the start of esterification and other at the end of esterification. The esterification is carried out between about 200° C. and about 240° C. for a period of about 215 minutes. Out of 215 minutes, vacuum distillation is carried out for about 30 minutes at about 500 mbar and the remaining time is consumed by atmospheric distillation carried out at about 1050 mbar. The prepolymer formed is transferred to the poly reactor and 90 ppm of TEPA (6.5 g) is added. The polymerization is conducted at between about 230° C. and about 260° C. for a period of about 190 minutes. After reaching the required kilowatt of the reactor, 4700 ppm Nyacol® (47 g), 1100 ppm of Acyln (11 g) and 10% of PBN (1 000 g) are added to the melt and mixed thoroughly. The amorphous polymer melt is extruded under nitrogen pressure and collected as pellets.

### Example 9

### Manufacture of PTN with 7% PBN

NDC and PDO are mixed in a molar ratio of 1:1.4 in an esterification reactor. To the esterification reactor manganese acetate (90 ppm as Mn, 4.16 g) and cobalt acetate (70 ppm as Co, 2.9 g) are added. About 200 ppm of tin oxide (3.5 g) and about 25 ppm of tungsten trioxide (0.25 g) are added in two equal parts, one at the start of esterification and other at the end of esterification. The esterification is carried out between about 200° C. and about 230° C. for a period of about 240 minutes. Here the atmospheric distillation is carried out at about 1050 mbar for about 210 minutes and vacuum distillation at about 500 mbar for about 30 minutes, for a total of 180 minutes. The prepolymer formed is transferred to a poly reactor. TEPA is added such that the phosphorus content in about 110 ppm (7.9 g). The polymerization is conducted at about 230° C. to about 250° C. for a period of about 159 minutes. After reaching the required kilowatt of the reactor, about 7% of PBN (700 g) is added to the melt and mixed thoroughly. The amorphous polymer melt is extruded under nitrogen pressure and collected as pellets.

### Example 10

### Manufacture of PTN—15% PBN

About 1:1.4 molar ratio of NDC and PDO are charged into an esterification reactor. About 180 ppm of tin oxide (3.2 g), 18 ppm of tungsten trioxide (0.18) and 60 ppm of manganese acetate (2.8 g) are added in two equal parts, one at the start of esterification and other at the end of esterification, except for manganese acetate, which is added at the start of esterification and at the middle of esterification. About 30 ppm of cobalt acetate (1.27 g) is also added to the esterification reactor. The esterification is carried out at between about 200° C. and about 230° C. for a period of about 238 minutes. The prepolymer formed is transferred to a poly reactor. TEPA is added such that its phosphorus content is about 130 ppm (9.4 g). The polymerization is conducted at very low pressure in the temperature range of about 230° C. to about 265° C. with a process time of about 159 minutes. After reaching the required kilowatt of the reactor agitator, about 25 ppm TBPA (0.25 g), 4500 ppm ethylene carbonate (45 g), 2800 ppm Nyacol® (28 g) and about 15 wt % of PBN (1500 g) are added to interact thoroughly with the melt. The amorphous polymer melt is extruded under nitrogen pressure and collected as pellets. Table VII provides resin composition from the above Examples.

TABLE VII

| Ingredients | | Eg 1 | Eg 2 | Eg 3 | Eg 7 | Eg 8 | Eg 9 | Eg 10 |
|---|---|---|---|---|---|---|---|---|
| Molar ratio | | 1:1.25 | 1:1.4 | 1:1.25 | 1:1.4 | 1:1.4 | 1:1.4 | 1:1.4 |
| Batch Weight | | 10000 | 10000 | 10000 | 10000 | 10000 | 10000 | 10000 |
| Manganese | g | 1.85 | | 1.85 | 2.8 | 2.8 | 4.16 | 2.8 |
| Acetate | ppm, as Mn | 40 | | 40 | 60 | 60 | 90 | 60 |
| Cobalt Acetate | g | 1.7 | | 1.7 | 2.1 | 2.5 | 2.9 | 1.27 |
| | ppm, as Co | 40 | | 40 | 50 | 60 | 70 | 30 |
| Tin oxide | g | 3.5 | | 3.5 | 3.8 | 2.6 | 3.5 | 3.2 |
| | ppm, as Sn | 200 | | 200 | 220 | 150 | 200 | 180 |
| Tungsten | g | | | 0.1 | 0.12 | 0.05 | 0.25 | 0.18 |
| trioxide | ppm, as such | | | 10 | 12 | 5 | 25 | 18 |
| TnBT | g | | 0.56 | | | | | |
| | ppm, as Ti | | 40 | | | | | |
| OPA | g | 0.7 | 1.7 | 1.4 | | | | |
| | ppm, as p | 20 | 50 | 40 | | | | |
| TEPA | g | 1.4 | 3.6 | | 5.07 | 6.5 | 7.9 | 9.4 |
| | ppm, as p | 20 | 50 | | 70 | 90 | 110 | 130 |
| Nanosilica/ | g | | | 100 | 35 | 47 | | 28 |
| Nanoclay | ppm, as such | | | 10000 | 3500 | 4700 | | 2800 |
| Nucleating agent | g | | | 2 | | 11 | | |
| | ppm, as such | | | 200 | | 1100 | | |
| TBPA | g | 0.5 | | 0.5 | 0.25 | | | 0.25 |
| | ppm, as such | 50 | | 50 | 25 | | | 25 |
| Ethylene | g | 50 | | 50 | 50 | | | 45 |
| carbonate | ppm, as such | 5000 | | 5000 | 5000 | | | 4500 |
| Sodium | g | | | 5 | | | | |
| Methoxide | ppm, as such | | | 500 | | | | |
| PBN | g | | | | 1500 | 1000 | 700 | 1500 |
| | wt % | | | | 15 | 10 | 7 | 15 |

Table VIII summarizes the important characteristics of the amorphous PTN polymer.

TABLE VIII

| | | Carboxyl | Dipropylene | | | | | | | |
|---|---|---|---|---|---|---|---|---|---|---|
| | I.V. | number | glycol | Acrolein | L* | a* | b* | Tg | Tm | Tch |
| S.No. | dL/g | meq/kg | wt % | ppm | CIE | CIE | CIE | ° C. | ° C. | ° C. |
| 1. | 0.437 | 11 | 0.043 | 0.7 | 80.7 | −1.8 | −1 | 75.5 | 201.2 | 159.6 |
| 2. | 0.451 | 7 | 0.072 | 1.22 | 77.8 | −3.1 | 2.1 | 77.5 | 202.7 | 168.9 |
| 3. | 0.437 | 12 | 0.064 | 4.6 | 80.6 | −1.9 | 0.1 | 77.9 | 201.9 | 167.2 |
| 4. | 0.426 | 11 | 0.094 | 1.16 | 79 | −2.4 | 0.5 | 76.2 | 202.4 | 164.3 |

### INCORPORATION BY REFERENCE

The contents of all cited references (including literature references, patents, patent applications, and websites) that maybe cited throughout this application are hereby expressly incorporated by reference. The practice of the present invention will employ, unless otherwise indicated, conventional techniques of polyester resin manufacture, which are well known in the art.

### Equivalents

The invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims rather than by the foregoing description, and all changes that come within the meaning and range of equivalency of the claims are therefore intended to be embraced herein.

We claim:

1. A polymer comprising about 75% polyethylene terephthalate (pet) and about 25% of: a material selected from the group consisting of polytrimethylene naphthalate (PTN), polybutylene naphthalate (PBN), and a combination thereof.

2. A polymer comprising about 75% polyethylene terephthalate (PET), about 20% of a material selected from the group consisting of polytrimethylene naphthalate (PTN), polybutylene naphthalate (PBN), and a combination thereof, and about 5% of a material selected from the group consisting of polybutylene terephthalate (PBT), isophthalic acid (IPA), and a combination thereof.

3. A polymer for use as a core layer in a multilayer composition, the polymer comprising about 100% of a material selected from the group consisting of polytrimethylene naphthalate (PTN), polybutylenenaphthalate (PBN), and a combination thereof.

4. A polymer for use as a core layer in a multilayer composition, the polymer comprising about 85% of a material selected from the group consisting of polytrimethylene naphthalate (PTN), polybutylenenaphthalate (PBN), and a combination thereof, and about 15% of a material selected from the group consisting of polybutyleneterephthalate (PBT), polyethyleneterephthalate (PET), isophthalic acid (IPA), and combinations thereof.

5. A polymer for use as a core layer in a multilayer composition, the polymer comprising about 85% polytrimethylenenaphthalate (PTN) and about 15% poly butylenenaphthalate (PBN).

6. A polymer for use as a core layer in a multilayer composition, the polymer comprising about 85% polybutylenenaphthalate (PBN) and about 15% of a material selected from the group consisting of polyethylene terephthalate (PET), isophthalic acid (IPA), and a combination thereof.

7. A polymer for use as a core layer of a multilayer composition, the polymer comprising about 85% polyethylene terephthalate (PET) and about 15% of a material selected from the group consisting of polytrimethylene naphthalate (PTN), polybutylenenaphthalate (PBN), polybutyleneterephthalate (PBT), and combinations thereof.

8. A polymer for use as an inner layer or an outer supporting layer of a multilayer composition, the polymer comprising about 85% polyethylene terephthalate (PET) and about 15% of a material selected from the group consisting of polytrimethylene naphthalate (PTN), polybutylenenaphthalate (PBN), and combinations thereof.

9. The polymer for use as an inner layer or outer layer of claim 8, wherein the 85% PET comprises about 10 to about 20% Post Consumer Recycled PET (PCRPET).

10. The polymer for use as an inner layer or outer layer of claim 8, wherein the 85% PET comprises about 20% Post Consumer Recycled PET (PCRPET).

11. The polymer for use as an inner layer or outer layer of claim 8, wherein the Post Consumer Recycled PET (PCRPET) is combined with the PET through in situ glycolysis and polymerization of purified terephthalic acid (PTA) and monoethylene glycol (MEG) in the same reactor.

12. The polymer for use as an inner layer or outer layer of claim 8, further comprising at least one additive selected from the group consisting of a CO₂ barrier, an oxygen scavenger, a nucleating agent, a thermal stabilizer, and a clear fast heat additive.

13. The polymer of claim 8, further comprising a CO₂ barrier additive.

14. The polymer of claim 13, wherein the CO₂ barrier is selected from the group consisting of PTN, PBN, and a combination thereof.

15. The polymer of claim 8, further comprising an oxygen scavenger additive.

16. The polymer of claim 15, wherein the oxygen scavenger comprises a metallic particle or a polymeric compound.

17. The polymer of claim 15, wherein the oxygen scavenger is selected from the group consisting of Amosorb®, iron, copper, and cobalt.

18. The polymer of claim 15, wherein the oxygen scavenger is present in the range of about 1000 to about 6000.

19. The polymer of claim 15, wherein the oxygen scavenger is present in the range of about 2500 to about 3500.

20. The polymer of claim 8, further comprising a nucleating agent.

21. The polymer of claim 20, wherein the nucleating agent is selected from the group consisting of nano clay, nano silica, micronized zinc oxide, micronized sodium benzoate, sorbitol, ethylene acrylic acid sodium ionomer, sodium salicylate, talc, and combinations thereof.

22. The polymer of claim 8, further comprising a thermal stabilizer.

23. The polymer of claim 22, wherein the thermal stabilizer is selected from the group consisting of orthophosphoric acid (OPA), tetraethyl phosphonium acetate (TEPA), trimethyl phosphite, phosphoric acid, and combinations thereof.

24. The polymer of claim 8, further comprising a clear fast heat additive.

25. The polymer of claim 24, wherein the clear fast heat additive is selected from the group consisting of tungsten metal powder, tungsten oxide, tungsten trioxide, tungsten carbide, and combinations thereof.

26. A monolayer container comprising the polymer of claim 1 or 2.

27. A multilayer container comprising a core layer of any one of claims 3-7.

28. The multilayer container of claim 27, further comprising at least one of an inner layer and an outer layer of claim 8.

29. The multilayer container of claim 27, wherein the core layer comprises a thickness of about 4% to about 20% of a total thickness of the layers.

30. The multilayer container of claim 27, wherein the core layer comprises a thickness of about 20 microns and the inner and/or outer layer comprises a thickness of about 200 microns.

31. A container that can be tunnel pasteurized at between about 60° C. and about 70° C. and hot filled at between about 85° C. and about 100° C.

32. The container of any one of claims 27-31, wherein the container is a bottle.

33. The container of claim 32, wherein the container is a beer bottle.

34. The container of claim 32, wherein the container is a carbonated soft drink bottle.

35. A method for producing a PTN polymer, the method comprising the steps of:
(a) adding NDC and PDO or BDO to an esterification reactor;
(b) adding an esterification catalyst;
(c) adding at least one additive selected from the group consisting of a clear fast reheat additive, a nano compound, a tin compound, and a nucleating agent and incubating to form a prepolymer;
(d) transferring the prepolymer to a poly reactor;
(e) adding at least one of a polymerization catalyst and a heat stabilizer and incubating at about 230° C. to about 270° C.;
(f) adding an agent selected from the group consisting of an end capping agent, an acrolein suppressor, a tetrahydrofuran (THF) suppressor, and a combination thereof, thereby creating a polymer melt; and
(g) extruding the polymer melt under nitrogen pressure to form pellets.

36. The method of claim 35, further comprising vacuum distillation during step (c) and (e).

37. A method for producing a PTN polymer, the method comprising the steps of:
(a) adding NDC and PDO to an esterification reactor;
(b) adding an esterification catalyst, a clear fast reheat additive, a nano compound, and a nucleating agent and incubating to form a prepolymer;
(c) transferring the prepolymer to a poly reactor;
(d) adding a polymerization catalyst and a heat stabilizer and incubating at about 230° C. to about 270° C.;
(e) adding an end capping agent, an acrolein suppressor, and a tetrahydrofuran (THF) suppressor to create a polymer melt; and
(f) extruding the polymer melt under nitrogen pressure to form pellets.

38. A method for producing a PBN polymer, the method comprising the steps of:
(a) adding NDC and BDO to an esterification reactor;
(b) adding an esterification catalyst, a clear fast reheat additive, a nano compound, and a nucleating agent and incubating to form a prepolymer;
(c) transferring the prepolymer to a poly reactor;
(d) adding a polymerization catalyst and a heat stabilizer and incubating at about 230° C. to about 270° C.;
(e) adding an end capping agent, an acrolein suppressor, and a THF suppressor to create a polymer melt; and
(f) extruding the polymer melt under nitrogen pressure to form pellets.

39. A method for producing PTN with 15% PBN, the method comprising the steps of:
(a) adding NDC and PDO to an esterification reactor;
(b) adding an esterification catalyst;
(c) adding tin and tungsten trioxide in two equal parts, one at the start of esterification and other at the end of esterification and incubating to form a prepolymer;
(d) transferring the prepolymer to a poly reactor;
(e) adding TEPA and incubating at about 230° C. to about 250° C.;
(f) adding TBPA, ethylene carbonate, PBN, and Nyacol® to create a polymer melt; and
(g) extruding the polymer melt under nitrogen pressure to form pellets.

40. A method for producing PTN with 10% PBN, the method comprising the steps of:
(a) adding NDC and PDO to an esterification reactor;
(b) adding an esterification catalyst;
(c) adding tin oxide and tungsten trioxide in two equal parts, one at the start of esterification and other at the end of esterification and vacuum distilling for about 30 minutes followed by atmospheric distilling for about 185 minutes;
(d) transferring the prepolymer to a poly reactor;
(e) adding TEPA and incubating at about 230° C. to about 260° C.;
(f) adding PBN, Nyacol®, and Acyln to create a polymer melt; and
(g) extruding the polymer melt under nitrogen pressure to form pellets.

41. A method for producing PTN with 7% PBN, the method comprising the steps of:
(a) adding NDC and PDO to an esterification reactor;
(b) adding an esterification catalyst;
(c) adding tin oxide and tungsten trioxide in two equal parts, one at the start of esterification and other at the end of esterification and vacuum distilling for about 30 minutes followed by atmospheric distilling for about 180 minutes;
(d) transferring the prepolymer to a poly reactor;
(e) adding TEPA and incubating at about 230° C. to about 250° C.;
(f) adding PBN to create a polymer melt; and
(g) extruding the polymer melt under nitrogen pressure to form pellets.

42. A method for producing PTN with 7% PBN, the method comprising the steps of:
(a) adding NDC and PDO to an esterification reactor;
(b) adding tin oxide, tungsten trioxide, cobalt acetate and manganese acetate in two equal parts, one at the start of esterification and other at the end of esterification, and incubating at about 200° C. and about 230° C.;
(c) transferring the prepolymer to a poly reactor;
(d) adding TBPA, ethylene carbonate, Nyacol®, and PBN and incubating at about 230° C. to about 245° C. for about 159 minutes;
(e) adding PBN to create a polymer melt; and
(f) extruding the polymer melt under nitrogen pressure to form pellets.

43. The method of claim 35, wherein the esterification catalyst is selected from the group consisting of manganese acetate, cobalt acetate, calcium acetate, zinc acetate, and combinations thereof.

44. The method of claim 35, wherein the clear fast reheat additive is selected from the group consisting of tungsten metal powder, tungsten oxide, tungsten trioxide, tungsten carbide, and combinations thereof.

45. The method of claim 35, wherein the nanocompound is selected from the group consisting of nano clay, nano silica, and combinations thereof.

46. The method of claim 35, wherein the nucleating agent is selected from the group consisting of nano clay, nano silica, micronized zinc oxide, micronized sodium benzoate, sorbitol, ethylene acrylic acid sodium ionomer, sodium salicylates, talc, and combinations thereof.

47. The method of claim 35, wherein the polymerization catalyst is selected from the group consisting of tin oxide, tetrabutyl titanate (TnBT), antimony trioxide, butylstannoic acid, and combinations thereof.

48. The method of claim 35, wherein the heat stabilizer is selected from the group consisting of orthophosphoric acid (OPA), tetraethyl phosphonium acetate (TEPA), trimethyl phosphite, phosphoric acid, and combinations thereof.

49. The method of claim 35, wherein the acrolein suppressor is ethylene carbonate.

50. The method of claim 35, wherein the THF suppressor is selected from the group consisting of sodium methoxide, sodium phosphate, sodium citrate, and combinations thereof.

51. The method of claim 35, further comprising the steps of:
(h) precrystallising the pellets at 140° C. in a fluid bed precrystallizer followed by cooling;
(i) transferring the chips to a tumbling dryer and increasing the temperature to about 35° C. to about 180° C. with nitrogen bleeding and maintaining the temperature for about 5 to about 8 hours;
(j) maintaining the temperature at about 180° C. for about 3 hours while pressurized with nitrogen at 0.5 bar g; and
(k) releasing the pressure and evacuating the dryer to a pressure level of 1.0 mbar.
